(19) United States
(12) Patent Application Publication
(10) Pub. No.: US 2023/0292847 A1
(43) Pub. Date: Sep. 21, 2023

(54) CONTROL CIRCUITRY FOR AN AEROSOL-GENERATING DEVICE

(71) Applicant: Philip Morris Products S.A., Neuchatel (CH)

(72) Inventors: Gregory Andre CRISTIAN, Cortaillod (CH); Christian WAGNER, Echandens (CH)

(73) Assignee: Philip Morris Products S.A., Neuchatel (CH)

(21) Appl. No.: 18/041,735

(22) PCT Filed: Aug. 4, 2021
(86) PCT No.: PCT/EP2021/071728

§ 371 Date: Feb. 15, 2023

(30) Foreign Application Priority Data
Aug. 19, 2020 (EP) 20191764.8

(51) Int. Cl. A24F 40/53; A24F 40/60; A24F 40/65; G06F 21/31

(52) U.S. Cl. CPC A24F 40/53; A24F 40/60; A24F 40/65; G06F 21/31

(57) ABSTRACT

Control circuitry is provided for an aerosol-generating device having a locked state in prohibiting aerosol delivery and an unlocked state permitting aerosol delivery, the circuitry being configured to: receive user-input authentication information from user interface components, to receive the information during multiple time windows, each corresponding to a respective digit of a sequence of digits forming the information, and to attribute user input received via the components during a time window to the digit corresponding to the time window, perform offline authentication of the device based on the information, determine to transition the device from the locked state to the unlocked state based on a successful result of the offline authentication, and interpret multiple signals arising from repeated user operation of a same user interface component during the time window as a coded input signal defining the digit of the sequence to which the time window corresponds.

The present disclosure generally relates to the field of aerosol-generating devices and systems.

Aerosol-generating systems usually comprise an aerosol-generating device for generating an aerosol and a companion device, which may be called a companion device or main unit, for storing the aerosol-generating device. Typically, aerosol-generating devices are designed as handheld devices that can be used by a user for consuming, for instance in one or more usage sessions, aerosol generated by an aerosol-generating article. Usually, aerosol-generating articles comprise an aerosol-forming substrate, such as a tobacco containing substrate, and/or a cartridge comprising a liquid. For generating the aerosol during use or consumption, for example, heat can be applied or transferred from a heating element or heat source in the aerosol-generating device (or in the aerosol-generating article) to heat at least a portion of the aerosol-forming substrate.

Exemplary aerosol-generating articles for use with aerosol-generating devices can comprise an aerosol-forming substrate that is assembled, often with other elements or components, in the form of a stick. Such a stick can be configured in shape and size to be inserted at least partially into the aerosol-generating device, which, for example, can comprise a heating element for heating the aerosol-generating article and/or the aerosol-forming substrate. Other exemplary aerosol-generating articles can comprise a cartridge containing a liquid that can be vaporized during aerosol consumption by the user. Also, such a cartridge can be configured in shape and size to be inserted at least partially into the aerosol-generating device. Alternatively, the cartridge may be fixedly mounted to the aerosol-generating device and refilled by inserting liquid into the cartridge.

It is desirable to perform youth access prevention (YAP) activation methods to prevent underage users from accessing and using such aerosol-generating devices. Some YAP methods may require the user to register the device and activate it for use by connecting the device to a computing device such as a smartphone, personal computer or the like on which a registration application is running. The application may be provided as a USB application. The connection to the computing device may be achieved via Bluetooth Low Energy (BLE).

Despite the ubiquity of smartphones, tablets, personal computers, and the like, the inventors have recognised that the connectivity and the applications required in order for the YAP method to be performed in the above-described manner may be technically problematic and that it may therefore be desirable to provide for an improved aerosol-generating device or system and/or an improved companion device which allow authentication such as YAP methods to be performed without relying on any device connectivity and without the use of any external application.

This is achieved by the subject-matter of the independent claims. Optional features are provided by the dependent claims and by the following description.

According to a first aspect, there is provided control circuitry for an aerosol-generating device. The aerosol-generating device has a locked state in which the aerosol-generating device is prohibited from delivering aerosol and an unlocked state in which the aerosol-generating is permitted to deliver aerosol. The control circuitry is configured to receive user-input authentication information from one or more user interface components. The control circuitry is configured to receive the user-input authentication information during multiple time windows of predetermined duration, each time window corresponding to a respective digit of a sequence of digits forming the authentication information, and to attribute user input received via the user interface components during a said time window to the digit corresponding to the said time window. The control circuitry is further configured to perform offline authentication of the aerosol-generating device based on the user-input authentication information; and determine to transition the aerosol-generating device from the locked state to the unlocked state based on a successful result of the offline authentication.

By performing the authentication offline, authentication such as a YAP method can be performed without relying on any device connectivity and without the use of any external application. Transitioning of the aerosol-generating device into the unlocked state by an unauthorized user can be effectively and reliably be prohibited, such that use of the aerosol-generating device for aerosol consumption by unauthorized users can be effectively and reliably prevented.

As used herein, “offline” refers to an authentication which is connectivity-free, connectivity-agnostic, or connectivity-independent, in the sense that the authentication is performed while the aerosol-generating device or the aerosol-generating system comprising the aerosol-generating device is in a disconnected or offline state during the authentication. For example, the control circuitry may be further configured to perform offline authentication of the aerosol-generating device without the aerosol-generating device (or any part of a system comprising the aerosol-generating device) being connected (or required to be connected) to an external computing device (e.g. a mobile phone, personal computer, or tablet device) during the authentication (and/or in order for the authentication to be completed). Additionally or alternatively, the control circuitry may be further configured to perform offline authentication of the aerosol-generating device without transmitting authentication-relevant data to, or receiving authentication-relevant data from, an external computing device during the authentication, even in the case that the aerosol-generating device is connected to the external computing device, “authentication-relevant data” comprising for example data that is used by or necessary for the authentication. The control circuitry may be further configured to perform offline authentication of the aerosol-generating device without being controlled by, and/or without controlling, an external computing device during the authentication. The control circuitry may be further configured to perform offline authentication of the aerosol-generating device without the aerosol-generating device being connected to or forming part of a network including one or more external computing devices, for example the internet. “Offline” may refer to any connectivity of the aerosol-generating device not being used for authentication-related purposes or tasks, regardless of whether the aerosol-generating device is connected/connectable to an external computing device. For example, “offline” may refer to a state in which data exchanged during the authentication by any communications interface of the aerosol-generating device which provide its connectivity not being input to, or output from, the control circuitry, or, more particularly, the threads or components thereof which are performing authentication-related tasks. In other words, the aerosol-generating device may comprise a communications interface for managing a connection to an external computing device, with “offline” indicating that, during the authentication, the communications interface remains idle or performs only tasks unrelated to the authentication. It should be noted that the term “external computing device” when used in relation to the term “offline” does not include either the companion device or the aerosol-generating device, where authentication is performed by the other of those devices.

The control circuitry may be further configured to control the user interface components to guide the user in inputting the authentication information as part of a guided interactive input process, for example by controlling the user interface components to output user-perceptible guidance signals in response to control signals from the control circuitry for guiding the user during the guided interactive input process, such as to (i) prompt the user to take predetermined action, to (ii) provide the user with feedback relating to progress of the guided interactive input process, or both (i) and (ii). The interactive input process is thus one example of a guided human-machine interaction process. The user-perceptible guidance signals may comprise any one or more of visual signals, audible signals, and haptic signals. To this end, the user interface components may comprise one or more output elements, including for example any combination of one or more of the following elements: a visual indicator (such as a light source, for example an LED, incandescent tube, compact fluorescent lamp), a haptic output element (such as an eccentric rotating mass motor, linear resonant actuator, vibrotactile actuator such as a C2 tactor, a piezoelectric actuator), an audible output element such as a speaker or the like. The user interface components further comprise one or more input elements such as a button (e.g. a pushbutton), touchscreen, microphone. In one implementation, the user interface components comprise a plurality of LEDs and a pushbutton. In any of these ways, the user interface components facilitate implementation of the offline authentication while conserving device real estate in what may be a small-form-factor aerosol-generating device or companion device.

The sequence of digits forming the authentication information may comprise a personal identification number or code, e.g. a pin code. Thus, a separate time window is provided for entry of each digit of the sequence or pin code, thereby providing certainty and security concerning which digit is currently being entered. By “attribute” is meant that the control circuitry associates the user input received during the said time window to the digit corresponding to the said time window, or that the control circuitry uses that user input received during the said time window to determine or calculate the value of the digit corresponding to the said time window. To enhance security, the control circuitry may be configured to trigger a timeout in response to no user input being received by the one or more user interface components within a predetermined time period starting from the beginning of a respective one of the time windows. Consequently, the control circuitry may be further configured to determine not to transition the aerosol-generating device to the unlocked state in response to the triggering of the timeout. By “timeout” is meant that a timer begins running at the start of the predetermined period and at the end of the predetermined period an interrupt or trigger signal is generated, thereby “triggering” the timeout, if predetermined action was not taken to cancel or reset the timer during the predetermined period.

The control circuitry may be configured to initiate a first one of the time windows in response to a user interacting with the one or more user interface components. For instance, the control circuitry may be configured to initiate a first one of the time windows in response to receiving a predetermined signal (or signals) generated by a user interacting with the one or more user interface components. In one example, the one or more user interface components may comprise a pushbutton, and the predetermined signal may be generated by the user pressing the pushbutton a predetermined number of times. For instance, the first time window may be initiated by the user pressing the pushbutton a predetermined number of times (e.g. 5) within a predetermined amount of time (e.g. 30 seconds).

Before and/or during one or more of the time windows (for instance, before and/or during the first time window), there may be a preliminary time window. If no user-input authentication is received during the preliminary time window then the control circuitry will determine an unsuccessful result of the offline authentication. However, if user-input authentication is received during the preliminary time window, the received user-input authentication is stored (to be attributed to the corresponding digit) and the corresponding time window will be initiated and/or continue running (to allow the corresponding digit to be completed).

To assist in guiding the user through the interactive input process, the control circuitry may be further configured to control the user interface components to output user-perceptible guidance signals indicating at least the beginnings of respective time windows, so that the user knows when input is expected. The user-perceptible guidance signals may also indicate that the time window is running, for example by emitting a continuous or blinking signal, e.g. a visual signal, to the user. To provide further certainty for the user, and to enhance interactivity, the control circuitry may be further configured to control the user interface components to output user-perceptible guidance signals indicating for which digit of the sequence the user is being guided to provide input. For example, the aerosol-generating device and/or companion device may be provided with a number of output elements corresponding to the number of digits in the sequence, where the position of an active output element with respect to the other, inactive output elements indicates the position of the digit within the sequence for which input is expected. The control circuitry may be further configured to interpret multiple signals arising from repeated user operation of a same said user interface component during a said time window as a coded input signal defining the digit of the sequence to which the said time window corresponds, such that only one user interface component, such as one button, can be used for inputting digits of any value, thereby saving device real estate. Advantageously, this one user interface component may be a power button of the aerosol-generating device or companion device, thus further saving real estate. In any of these ways, a guided interactive input process is facilitated for inputting the authentication information while placing only minimal requirements on the capability and size of the user interface components.

To hinder unauthorized users or other attackers who try to brute force the offline authentication process by attempting to input authentication information many times, the control circuitry may be further configured to respond to an unsuccessful result of the offline authentication by prohibiting the user from inputting further authentication information until a time delay period has expired, or by refraining from performing offline authentication based on user-input authentication information until a time delay period has expired. The control circuitry may be configured to increase the duration of the time delay period after each successive unsuccessful result of the offline authentication. In one particular example, the time delay period may become exponentially longer after each successive unsuccessful result, such that an exponential delay may be introduced between retries in order to deter the attacker.

The control circuitry may be further configured to compare the user-input authentication information with prestored reference authentication information and to determine, based on an outcome of the comparison, whether to transition the aerosol-generating device from the locked state to the unlocked state.

Performing authentication of the aerosol-generating device may mean or comprise identifying the user, determining an identity of the user, verifying an identity of the user, and/or determining whether or not the user is authorized or verified to transition the aerosol-generating device into the unlocked state to permit delivery and/or generation of aerosol. Accordingly, a “successful authorization” of the user may mean that the user was identified as being authorized for transitioning the aerosol-generating device into the unlocked state. An “unsuccessful authorization” of the user may mean that the user was not or was unsuccessfully identified as being authorized for transitioning the aerosol-generating device into the unlocked state.

The locked state of the aerosol-generating device may refer to a locked configuration and the unlocked state may refer to an unlocked configuration of the aerosol-generating device.

In the locked state or configuration, the aerosol-generating device is prohibited from delivering and/or generating aerosol. This may mean that the aerosol-generating device is locked for aerosol consumption by the user in the locked state and/or that the aerosol-generating device is configured in the locked state, such that no aerosol can be delivered and/or generated.

On the other hand, in the unlocked state or configuration, the aerosol-generating device is permitted or allowed to deliver and/or generate aerosol. This may mean that the aerosol-generating device is unlocked for consumption of aerosol by the user in the unlocked state and/or that the aerosol-generating device is configured in the unlocked state, such that aerosol can be delivered and/or generated.

Accordingly, when the aerosol-generating device is in the locked state, the aerosol-generating device may not be actuatable by the user to deliver and/or generate aerosol, and, when the aerosol-generating device is in the unlocked state, the aerosol-generating device may be actuatable by the user to deliver and/or generate aerosol. In other words, in the locked state of the aerosol-generating device, access to one or more functions or functionalities of the aerosol-generating device, including aerosol delivery and/or generation, may be prohibited for the user, and in the unlocked state of the aerosol-generating device, access to one or more functions or functionalities of the aerosol-generating device, including aerosol delivery and/or generation, may be permitted for the user.

Additionally or alternatively, the companion device may be configured to charge the energy storage of the aerosol-generating device only if there has been a successful authentication of the user. In this example, the locked state may be considered as the state in which the energy storage of the aerosol-generating device does not contain enough charge to cause aerosol to be generated, and the unlocked state may be considered as the state in which the energy storage contains enough charge to cause aerosol to be generated. The authentication signal may then be considered as the provision of charge to the energy storage of the aerosol-generating device by the companion device.

In the locked state, the control circuitry may, for example, be configured to prohibit activation of a heating element based on at least one of disabling the at least one heating element, disabling an energy supply for supplying electrical energy to the at least one heating element, and disabling an input element for actuating the at least one heating element by the user.

The control circuitry may be further configured to transition the aerosol-generating device to the unlocked state in response to determining to transition the aerosol-generating device from the locked state to the unlocked state based on a successful result of the offline authentication.

The control circuitry may be further configured to transition the aerosol-generating device to the unlocked state by one or more of (i) modifying a value of an authentication indicator stored in data storage, (ii) adding an authentication indicator to data storage, (iii) removing an authentication indicator from data storage.

Additionally or alternatively, the control circuitry may be further configured to transition the aerosol-generating device to the unlocked state by enabling one or more functions of the aerosol-generating device that was previously disabled when the aerosol-generating device was in the locked state.

Additionally or alternatively, the control circuitry may be further configured to transition the aerosol-generating device to the unlocked state by transmitting an unlock signal to a companion device for the aerosol-generating device, the companion device being configured to enable, in response to receipt of the unlock signal, one or more functions of one or more of the aerosol-generating device and the companion device that was previously disabled when the aerosol-generating device was in the locked state.

The one or more functions enabled in the unlocked state may be essential for the delivery of aerosol by the aerosol-generating device, the enabling comprising enabling one or more of: (i) electrical energy supply components (e.g. to charge the aerosol-generating device), (ii) vaporizable-liquid supply components, (iii) heating elements, (iv) airflow-enabling components.

Additionally or alternatively, the control circuitry may be further configured to transition the aerosol-generating device to the unlocked state by disabling one or more mechanical lock components, which are configured when in an enabled state to prevent the delivery and/or generation of aerosol.

The control circuitry may be further configured to determine not to transition the aerosol-generating device from the locked state to the unlocked state based on an unsuccessful result of the offline authentication. The control circuitry may be further configured to maintain the aerosol-generating device in the locked state in response to determining not to transition the aerosol-generating device from the locked state to the unlocked state based on an unsuccessful result of the offline authentication.

As used herein, “transitioning” may mean entering, configuring and/or switching the aerosol-generating device into the locked or unlocked state, which may mean or comprise actuating and/or configuring the aerosol-generating device such that the aerosol-generating device is in the locked or unlocked state.

The aerosol-generating device and/or the companion device and/or a system comprising the aerosol-generating device and the companion device may further include a data storage and the control circuitry may be configured to determine, based on an authentication signal such as that described herein, an authentication indicator and to store the authentication indicator in the data storage. The control circuitry may be configured to derive the authentication indicator from an authentication signal as described herein.

The authentication indicator may be indicative, representative and/or descriptive of a successful or an unsuccessful authentication of the user. Additionally or alternatively, the authentication indicator may be indicative, representative and/or descriptive of whether or not the user is authorized to transition the aerosol-generating device into the unlocked state. Accordingly, the authorization indicator may be usable for transitioning the aerosol-generating device into the locked state or the unlocked state or retaining it in the respective state. In other words, the authentication indicator may facilitate transitioning and/or being usable for transitioning the aerosol-generating device into the locked or unlocked state, to enter the locked or unlocked state, to switch into the locked or unlocked state, and/or to at least temporarily retain the aerosol-generating device in the locked or unlocked state. In particular, the aerosol-generating device may be transitioned into, or retained in, the locked state if or when the authentication indicator is indicative of an unsuccessful authentication of the user, and transitioned into, or retained in, the unlocked state if or when the authentication indicator is indicative of a successful authentication of the user.

Storing the authentication indicator in the data storage of the aerosol-generating may allow for an efficient, reliable and secure transition of the aerosol-generating device into the locked state or unlocked state as well as at least temporary retention of the aerosol-generating device in the so-configured locked or unlocked state, for example even when the companion device is currently not available to the user. Protection in case of loss of the aerosol-generating device may also be provided. The authentication indicator may refer to an anonymized data element indicating whether authentication of the user was successful or unsuccessful.

For example, the authentication indicator may refer to a data element, such as a binary data element, wherein a first value may indicate successful authentication of the user at the companion device and a second value, different than the first value, may indicate unsuccessful authentication of the user at the companion device. Further, the aerosol-generating device may be transitioned into or retained in the unlocked state if or when the authorization indicator takes the first value and transitioned into or retained in the locked state if or when the authentication signal takes the second value.

Additionally or alternatively, the aerosol-generating device may be transitioned into or retained in one of the locked and the unlocked state if or when the authorization indicator is present or stored in the data storage, and transitioned into or retained in the other one of the locked and the unlocked state if or when the authorization indicator is absent in the data storage. Accordingly, the control circuitry of the aerosol-generating device may be configured to transition the aerosol-generating device into, or retain it in, the locked state or the unlocked state based on the presence or absence of the authentication indicator in the data storage.

Further, the control circuitry of the aerosol-generating device may be configured to remove, delete and/or erase the authentication indicator from the data storage, such that the aerosol-generating device is thereby transitioned into the locked state. In other words, the aerosol-generating device may be transitioned into the locked state in absence of the authentication indicator in the data storage by removing the authentication indicator from the data storage.

For example, the control circuitry of the aerosol-generating device may be configured to periodically erase and/or delete the data storage for storing the authentication indicator, such that the aerosol-generating device is periodically transitioned into the locked state. By periodically removing the authentication indicator from the data storage and/or by periodically erasing the data storage, the aerosol-generating device can be periodically transitioned into the locked state. Accordingly, the user may be required to authorize or re-authorize themselves periodically, thereby efficiently, reliably and securely preventing use of the aerosol-generating device by an unauthorized user.

Additionally or alternatively, the control circuitry of the aerosol-generating device may be configured to modify, alter, adjust and/or change a value of the authentication indicator, such that the aerosol-generating device is transitioned into the locked state. The control circuitry of the aerosol-generating device may be configured to modify, alter, adjust and/or change the value of the authentication indicator to a value associated with the locked state, such as the second value of the authentication indicator. By periodically modifying the value of the authentication indicator, the aerosol-generating device can be periodically transitioned into the locked state. Accordingly, the user may be required to authorize or re-authorize themselves periodically, thereby efficiently, reliably and securely preventing use of the aerosol-generating device by an unauthorized user.

The aerosol-generating device may include at least one heating element configured to heat an aerosol-generating article to generate the aerosol, wherein the control circuitry of the aerosol-generating device may be configured to prohibit activation of the at least one heating element by the user when the aerosol-generating device is in the locked state. Moreover, the control circuitry of the aerosol-generating device may be configured to permit activation of the at least one heating element by the user, when the aerosol-generating device is in the unlocked state. By permitting activation of the heating element in the unlocked state and prohibiting activation of the heating element in the locked state, it can be ensured that the user can only use the aerosol-generating device for aerosol consumption upon successful authorization.

By way of example, the control circuitry of the aerosol-generating device may be configured to prohibit activation of the heating element based on at least one of disabling the at least one heating element, disabling an energy supply for supplying electrical energy to the at least one heating element, and disabling an actuation element of the aerosol-generating device for actuating the at least one heating element by the user.

Additionally or alternatively, a flow path of the aerosol through the aerosol-generating device may be blocked in the locked state, and the flow path may be opened or unblocked in the unlocked state for example by enabling one or more airflow-enabling components. Additionally or alternatively, insertion of an aerosol-generating article into the aerosol-generating device may be prohibited in the locked state, and insertion of the aerosol-generating article may be permitted in the unlocked state. However, any other means for permitting aerosol-generation in the unlocked state and prohibiting aerosol-generation in the locked state may be implemented.

The aerosol-generating device may be transitioned into or retained in one of the locked and the unlocked state if or when an authentication signal is generated or transmitted by the control circuitry, and transitioned into or retained in the other one of the locked and the unlocked state if or when no authentication signal is generated or transmitted by the control circuitry. To this end, the control circuitry may generate and/or transmit an authentication signal usable for transitioning the aerosol-generating device into the locked or unlocked state. In other words, the authentication signal may refer to a data signal or a data element allowing transitioning and/or being usable for transitioning the aerosol-generating device into the locked or unlocked state, to enter the aerosol-generating device into the locked or unlocked state, and/or to switch the aerosol-generating device into the locked or unlocked state. The authentication signal may refer to a binary signal, wherein a first value may indicate successful authentication of the user and a second value, different than the first value, may indicate unsuccessful authentication of the user. Further, the aerosol-generating device may be transitioned into or retained in the unlocked state if the authentication signal takes the first value and transitioned into the locked state or retained therein if the authentication signal takes the second value. Accordingly, the authentication signal may refer to an anonymized data signal or data element indicating whether authentication of the user was successful or unsuccessful.

Further, the authentication signal may be an encrypted signal. For example, a secret or a pass code may be shared for example between the aerosol-generating device and the companion device for encrypting the authentication signal. Therein, the secret or pass code may be encoded or included in the authentication signal. Alternatively, the secret or pass code may be transmitted separately from the authentication signal. However, any other encryption approach may be applied to encrypt the authentication signal. Generally, by encrypting the authentication signal, for example an attack of an unauthorized user to configure the aerosol-generating device into the unlocked state, such as a reply attack, can be reliably prevented. Further, the authentication indicator may be stored in a protected storage area of the data storage of the companion device and/or the aerosol-generating device.

The aerosol-generating device may be configured or designed as a hand-held device usable by the user or authorized user to consume an aerosol-generating article, for example during one or more usage sessions (also referred to as “experiences” or “experience sessions”). For instance, an aerosol-generating article usable with the aerosol-generating device can comprise an aerosol-forming substrate, such as a tobacco containing substrate, which may be assembled, optionally with other elements or components, in the form of a stick at least partially insertable into the aerosol-generating device. Additionally or alternatively, an aerosol-generating article usable with the aerosol-generating device can comprise at least one cartridge containing a liquid that can be vaporized during aerosol consumption by the user. Such cartridge can be a refillable cartridge fixedly mounted at the aerosol-generating device or the cartridge can be at least partially inserted into the aerosol-generating device.

The control circuitry may further control one or more functions or functionalities of the aerosol-generating device. The control circuitry may comprise one or more processors for data processing. Additionally or alternatively, the aerosol-generating device may comprise a data storage and/or memory for storing data, such as for example software instructions, a computer program, and/or other data.

The companion device, also describable as a receiving device, may generally refer to a supporting device for supporting and/or storing the aerosol-generating device. The companion device may be a portable companion device. In the context of the present disclosure, the companion device may be configured for at least partially receiving the aerosol-generating device. This is to be construed broadly. For example, this may mean that the companion device is configured for being physically coupled to the aerosol-generating device. Such physical coupling can, for example, comprise a mechanical coupling based on an attachment means, such as a hook mechanism, a latch mechanism, a snap-fit mechanism or the like, based on which the aerosol-generating device can be mechanically coupled to the companion device and/or a housing thereof. Additionally or alternatively, the aerosol-generating device can be physically coupled to the companion device based on a magnetic or electromagnetic coupling. Additionally or alternatively, the aerosol-generating device can be at least partially inserted into the companion device, for example, into an opening of the companion device. Further, the aerosol-generating device and the companion device may refer to physically separate components or elements of an aerosol-generating system.

In the context of the present disclosure, the external computing device may refer to a computing device configured to communicate with the aerosol-generating device and/or the companion device, for example based on exchanging data or information. Generally, the external computing device may be a handheld or portable device. Alternatively, the external computing device may be a stand-alone or fixedly installed device. Further, the external computing device may be in possession of or may be installed at the user or another entity or individual, such as a retail shop. By way of example, the external computing device may refer to a handheld, a smart phone, a personal computer (“PC”), a tablet PC, a notebook, or a computer.

The external computing device may comprise a user interface. The external computing device may comprise one or more processors for data processing, such as for processing one or more user inputs received at the user interface. Additionally or alternatively, the external computing device may comprise a data storage and/or memory for storing data, such as for example software instructions, a computer program, and/or other data. Further, the external computing device may comprise a communications interface, communications module and/or communications circuitry for communicatively coupling the external computing device with the aerosol-generating device and/or the companion device, for example via the communications interface thereof. Thus, the external computing device may be configured for wireless and/or wired communication with the aerosol-generating device, with the companion device, or both. For instance, the external computing device may be configured for being communicatively coupled with the aerosol-generating device and/or companion device via an Internet connection, a wireless LAN connection, a WiFi connection, a Bluetooth connection, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

For communicating with each other and/or with the external computing device and/or for exchanging data or signals, each of the aerosol-generating device and the companion device may comprise at least one communications interface. The communications interfaces can be configured for wireless communication, for wired communication, or both. For instance, the communications interfaces can be configured for communicative coupling via an Internet connection, a wireless LAN connection, a WiFi connection, a Bluetooth connection including BLE, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

The aerosol-generating device and/or the companion device may include at least one energy storage for storing electrical energy and/or for supplying the aerosol-generating device with electrical energy. For example, the companion device may be configured to supply electrical energy to the aerosol-generating device to charge the at least one energy storage of the aerosol-generating device. In other words, the companion device may be configured to charge the aerosol-generating device and/or the at least one energy-storage thereof. The at least one energy storage of the aerosol-generating device may, for example, comprise at least one battery, at least one accumulator, at least one capacitor or any other energy storage. The companion device may be configured to supply the energy storage of the aerosol-generating device with electrical energy, when the aerosol-generating device is at least partially received by the companion device. The companion device may comprise one or more batteries for supplying electrical energy to the energy storage of the aerosol-generating device. The companion device may be configured to supply the energy storage of the aerosol-generating device with electrical energy wirelessly, for example based on induction. Additionally or alternatively, the companion device may be configured to supply the energy storage of the aerosol-generating device with electrical energy via one or more electrical connectors between the companion device and the aerosol-generating device. For instance, the aerosol-generating device and the companion device may each include at least one electrical connector for electrically coupling the companion device with the aerosol-generating device, when the aerosol-generating device is at least partially received by the companion device. By way of example, the companion device may comprise an opening for at least partially receiving the aerosol-generating device. By at least partially inserting the aerosol-generating device into the opening, one or more electrical connections may be established between one or more electrical connectors of the aerosol-generating device and the companion device. Additionally or alternatively, the aerosol-generating device may be physically and/or mechanically coupled to the companion device, for example to a housing of the companion device, such that the aerosol-generating device is at least partially received by the companion device and such that one or more electrical connections can be established between the aerosol-generating device and the companion device. Optionally, establishing an electrical connection between the companion device and the aerosol-generating device, for example via the one or more electrical connectors of the aerosol-generating device and the companion device, may establish a communicative coupling and/or a communication connection between the companion device and the aerosol-generating device, for example for transmission of the authentication signal. By way of example, the at least one electrical connector of the companion device may be combined and/or may comprise the communications interface of the companion device. In other words, the at least one electrical connector of the companion device can be configured as communications interface for communicatively coupling the companion device with the aerosol-generating device. Additionally or alternatively, the at least electrical connector of the aerosol-generating device may be combined and/or may comprise the communications interface of the aerosol-generating device. In other words, the at least one electrical connector of the aerosol-generating device can be configured as communications interface for communicatively coupling the aerosol-generating device with the companion device. Accordingly, the authentication signal may be transmitted from the companion device to the aerosol-generating device via the one or more electrical connectors of the companion device and the aerosol-generating device. It should be noted, however, that the communications interface of one or both of the companion device and the aerosol-generating device can be physically separate and independent from the at least one electrical connector of the companion device and/or the aerosol-generating device. A charge cycle may refer to a period of time, in which the aerosol-generating device is continuously supplied with electrical energy by the companion device. During a charge cycle, the at least one energy storage may be partly or entirely charged.

For authenticating the user, reference authentication information may be stored in a data storage and/or memory of the aerosol-generating device and/or the companion device. For example, the reference authentication information may be acquired during and stored upon completion of an age verification process or registration process, as further discussed herein.

According to a second aspect, there is provided an aerosol-generating device comprising the control circuitry of the first aspect.

According to a third aspect, there is provided a companion device for an aerosol-generating device, the companion device comprising the control circuitry of the first aspect.

According to a fourth aspect, there is provided a system comprising an aerosol-generating device, a companion device for the aerosol-generating device, and the control circuitry of the first aspect. The control circuitry may for example be distributed between multiple components of the system including the aerosol-generating device and/or the companion device.

According to a fifth aspect, there is provided a method for authenticating an aerosol-generating device for use, the aerosol-generating device having a locked state in which the aerosol-generating device is prohibited from delivering aerosol and an unlocked state in which the aerosol-generating is permitted to deliver aerosol. The method comprises: receiving user-input authentication information from one or more user interface components during multiple time windows of predetermined duration, each time window corresponding to a respective digit of a sequence of digits forming the authentication information, and attributing user input received via the user interface components during a said time window to the digit corresponding to the said time window; performing offline authentication of the aerosol-generating device based on the user-input authentication information; and determining to transition the aerosol-generating device from the locked state to the unlocked state based on a successful result of the offline authentication.

The method may further comprise controlling the user interface components to guide the user in inputting the authentication information as part of a guided interactive input process. The method may further comprise controlling the user interface components to output user-perceptible guidance signals in response to control signals from the control circuitry for guiding the user during the guided interactive input process. The method may further comprise controlling the user interface components to output the user-perceptible guidance signals to (i) prompt the user to take predetermined action, to (ii) provide the user with feedback relating to progress of the guided interactive input process, or both (i) and (ii). The method may further comprise controlling the user interface components to output user-perceptible guidance signals comprising any one or more of visual signals, audible signals, and haptic signals.

The method may further comprise triggering a timeout in response to no user input being received by the one or more user interface components within a predetermined time period starting from the beginning of a respective one of the time windows. The method may further comprise determining not to transition the aerosol-generating device to the unlocked state in response to the triggering of the timeout. The method may further comprise controlling the user interface components to output user-perceptible guidance signals indicating at least the beginnings of respective time windows. The method may further comprise controlling the user interface components to output user-perceptible guidance signals indicating for which digit of the sequence the user is being guided to provide input. The method may further comprise interpreting multiple signals arising from repeated user operation of a same said user interface component during a said time window as a coded input signal defining the digit of the sequence to which the said time window corresponds. The method may further comprise responding to an unsuccessful result of the offline authentication by prohibiting the user from inputting further authentication information until a time delay period has expired, or by refraining from performing offline authentication based on user-input authentication information until a time delay period has expired. The method may further comprise increasing (e.g. exponentially increasing) the duration of the time delay period after each successive unsuccessful result of the offline authentication.

The method may further comprise comparing the user-input authentication information with prestored reference authentication information and determining, based on an outcome of the comparison, whether to transition the aerosol-generating device from the locked state to the unlocked state.

The method may further comprise transitioning the aerosol-generating device to the unlocked state in response to determining to transition the aerosol-generating device from the locked state to the unlocked state based on a successful result of the offline authentication. The method may further comprising transitioning the aerosol-generating device to the unlocked state by one or more of (i) modifying a value of an authentication indicator stored in data storage, (ii) adding an authentication indicator to data storage, (iii) removing an authentication indicator from data storage. The method may further comprise transitioning the aerosol-generating device to the unlocked state by enabling one or more functions of the aerosol-generating device that was previously disabled when the aerosol-generating device was in the locked state. The method may further comprise transitioning the aerosol-generating device to the unlocked state by transmitting an unlock signal to a companion device for the aerosol-generating device, the companion device enabling, in response to receipt of the unlock signal, one or more functions of one or more of the aerosol-generating device and the companion device that was previously disabled when the aerosol-generating device was in the locked state. The one or more functions enabled in the unlocked state may be essential for the delivery of aerosol by the aerosol-generating device, the enabling comprising enabling one or more of: (i) electrical energy supply components, (ii) vaporizable-liquid supply components, (iii) heating elements, (iv) airflow-enabling components. The method may further comprise transitioning the aerosol-generating device to the unlocked state by disabling one or more mechanical lock components. The method may further comprise determining not to transition the aerosol-generating device from the locked state to the unlocked state based on an unsuccessful result of the offline authentication. The method may further comprise maintaining the aerosol-generating device in the locked state in response to determining not to transition the aerosol-generating device from the locked state to the unlocked state based on an unsuccessful result of the offline authentication.

The method may further comprise performing offline authentication of the aerosol-generating device without being connected to an external computing device during the authentication. The method may further comprise performing offline authentication of the aerosol-generating device without transmitting authentication-relevant data to, or receiving authentication-relevant data from, an external computing device during the authentication.

The method of the fifth aspect may be performed for example by control circuitry of the aerosol-generating device, by control circuitry of a companion device for the aerosol-generating device, or by control circuitry of a system comprising the aerosol-generating device and a companion device for the aerosol-generating device.

According to a sixth aspect, there is provided a method comprising generating authentication information for offline authentication of an aerosol-generating device and sending the authentication information to the user for input to the control circuitry of the first aspect as the user-input authentication information. Generating the authentication information may comprise receiving an identity code from the user and generating the authentication information based on the received identity code. The method may further comprise, before generating the authentication information, performing an age verification process to verify the age of the user, and generating the authentication information only in response to a successful outcome of the age verification process.

The age verification process may be usable for determining whether the user of the aerosol-generating device has reached the minimum age as indicated by an age threshold. As used herein, “age threshold” may denote a predefined minimum age of a user of the aerosol-generating device. In certain jurisdictions, for example, aerosol consumption may be permitted for citizens or individuals having reached a certain minimum age and/or having an age equal to or above the minimum age. Further, at least in some jurisdictions, an individual having reached this minimum age may be regarded as being of full age and/or as being an adult. Accordingly, the term “age threshold” may be indicative, representative, and/or descriptive of the minimum age which a user should have for using the aerosol-generating device for aerosol consumption. Additionally or alternatively, the term “age threshold” may be indicative, representative, and/or descriptive of a majority age, above which the user may be regarded as an adult. For example, the age threshold may range from 14 years to 25 years, such as 16 years, 18 years or 21 years. The age verification process may thus be usable for determining whether the user of the aerosol-generating system is of full age, has reached majority age and/or is an adult. The age verification process may be associated with a registration procedure or a set-up procedure prior to or at a first use of the aerosol-generating device by the user.

Further, the age verification process may be performed using a user device, for example a telephone whereby the user contacts a call centre. By means of the external computing device, a comprehensive and secure procedure to determine the user's age can be implemented, for example based on personal data or information of the user, such as an identity card, a passport, a credit card, a driving license, a social security number of the user, or the like. Hence, the real age of the user can be reliably and unambiguously determined.

By determining that the user has reached the age threshold based on the age verification process, misuse or legally abusive use of the aerosol-generating device for aerosol consumption by a user not having reached the age threshold and/or having an age below the age threshold can be reliably and effectively prohibited. In particular, use of the aerosol-generating device for aerosol consumption by an underage user can be reliably and effectively prohibited.

As used herein, an “authorized user” (also referred to as “verified user”) can refer to or denote a proprietor of the aerosol-generating device, an adult, an adult individual, a user of full age, a user having reached the age threshold, a user having reached majority age, and/or a user that has been authorized to configure the aerosol-generating device by another authorized user, such as by the proprietor. Further, an unauthorized user can refer to or denote an underage user, a user not having reached an age threshold, a child, or any other user who is unauthorized to configure the aerosol-generating device, in particular unauthorized to transition the aerosol-generating device into the unlocked state for aerosol consumption.

According to a seventh aspect, there is provided a server computer comprising a processor configured to perform the method of any of the sixth aspect.

According to an eighth aspect, there is provided a computer program product comprising instructions which, when the program is executed by a server computer, cause the server computer to perform the method of the sixth aspect.

According to a variant of the first aspect, there is provided control circuitry for an aerosol-generating device. The aerosol-generating device has a locked state in which the aerosol-generating device is prohibited from delivering aerosol and an unlocked state in which the aerosol-generating is permitted to deliver aerosol. The control circuitry is configured to receive user-input authentication information from one or more user interface components; perform authentication of the aerosol-generating device based on the user-input authentication information; and determine to transition the aerosol-generating device from the locked state to the unlocked state based on a successful result of the authentication. The authentication optionally comprises or consists of the offline authentication described herein.

According to another variant of the first aspect, there is provided control circuitry for an aerosol-generating device having a locked state in which the aerosol-generating device is prohibited from delivering aerosol and an unlocked state in which the aerosol-generating is permitted to deliver aerosol, wherein the control circuitry is configured to receive user-input authentication information from one or more user interface components; perform offline authentication of the aerosol-generating device based on the user-input authentication information; and determine to transition the aerosol-generating device from the locked state to the unlocked state based on a successful result of the offline authentication.

According to a variant of the fifth aspect, there is provided a method for authenticating an aerosol-generating device for use, the aerosol-generating device having a locked state in which the aerosol-generating device is prohibited from delivering aerosol and an unlocked state in which the aerosol-generating is permitted to deliver aerosol, the method comprising: receiving user-input authentication information from one or more user interface components; performing offline authentication of the aerosol-generating device based on the user-input authentication information; and determining to transition the aerosol-generating device from the locked state to the unlocked state based on a successful result of the offline authentication.

It is emphasized that any feature, step, function, element, technical effect and/or advantage described herein with reference to one aspect equally applies to any other aspect of the present disclosure.

Below, there is provided a non-exhaustive list of non-limiting examples. Any one or more of the features of these examples may be combined with any one or more features of another example, embodiment, or aspect described herein.

Ex. 1 Control circuitry for an aerosol-generating device, the aerosol-generating device having a locked state in which the aerosol-generating device is prohibited from delivering aerosol and an unlocked state in which the aerosol-generating is permitted to deliver aerosol, the control circuitry being configured to:
receive user-input authentication information from one or more user interface components, wherein the control circuitry is configured to receive the user-input authentication information during multiple time windows of predetermined duration, each time window corresponding to a respective digit of a sequence of digits forming the authentication information, and to attribute user input received via the user interface components during a said time window to the digit corresponding to the said time window;
perform offline authentication of the aerosol-generating device based on the user-input authentication information; and
determine to transition the aerosol-generating device from the locked state to the unlocked state based on a successful result of the offline authentication.

Ex. 2 The control circuitry of example Ex. 1, further configured to control the user interface components to guide the user in inputting the authentication information as part of a guided interactive input process.

Ex. 3 The control circuitry of example Ex. 2, further configured to control the user interface components to output user-perceptible guidance signals in response to control signals from the control circuitry for guiding the user during the guided interactive input process.

Ex. 4 The control circuitry of example Ex. 3, further configured to control the user interface components to output the user-perceptible guidance signals to (i) prompt the user to take predetermined action, to (ii) provide the user with feedback relating to progress of the guided interactive input process, or both (i) and (ii).

Ex. 5 The control circuitry of example Ex. 3 or Ex. 4, further configured to control the user interface components to output user-perceptible guidance signals comprising any one or more of visual signals, audible signals, and haptic signals.

Ex. 6 The control circuitry of any of examples Ex. 1-Ex. 5, configured to trigger a timeout in response to no user input being received by the one or more user interface components within a predetermined time period starting from the beginning of a respective one of the time windows.

Ex. 7 The control circuitry of example Ex. 6, further configured to determine not to transition the aerosol-generating device to the unlocked state in response to the triggering of the timeout.

Ex. 8. The control circuitry of any of examples Ex. 1-Ex. 7, further configured to initiate a first one of the time windows in response to a user interacting with the one or more user interface components.

Ex. 9. The control circuitry of Ex. 8, further configured to initiate the first one of the time windows in response to receiving a predetermined signal generated by the user interacting with the one or more user interface components.

Ex. 10. The control circuitry of Ex. 9, wherein the one or more user interface components comprise a pushbutton, and the predetermined signal is generated by the user pressing the pushbutton a predetermined number of times.

Ex. 11. The control circuitry of any of examples Ex. 1-Ex. 10, wherein before and/or during one or more of the time windows, there is a preliminary time window, and wherein the control circuitry is configured to determine an unsuccessful result of the offline authentication if no user-input authentication is received during the preliminary time window, and to store the received user-input authentication and to initiate the corresponding time window and/or to continue running the corresponding time window if user-input authentication is received during the preliminary time window.

Ex. 12 The control circuitry of any of examples Ex. 1-Ex. 11, further configured to control the user interface components to output user-perceptible guidance signals indicating at least the beginnings of respective time windows.

Ex. 13. The control circuitry of any of examples Ex. 1-Ex. 12, further configured to control the user interface components to output user-perceptible guidance signals indicating that the said time window is running.

Ex. 14 The control circuitry of any of examples Ex. 1-Ex. 13, further configured to control the user interface components to output user-perceptible guidance signals indicating for which digit of the sequence the user is being guided to provide input.

Ex. 15. The control circuitry of Ex. 14, wherein the aerosol-generating device is provided with a number of output elements corresponding to the number of digits in the sequence, and wherein the position of an active output element with respect to inactive output elements indicates the position of the digit within the sequence for which input is expected.

Ex. 16 The control circuitry of any of claims Ex. 1-Ex. 15, further configured to interpret multiple signals arising from repeated user operation of a same said user interface component during a said time window as a coded input signal defining the digit of the sequence to which the said time window corresponds.

Ex. 17. The control circuitry of Ex. 16, wherein the said user interface component is a power button of the aerosol-generating device.

Ex. 18. The control circuitry of any of Ex. 1-Ex. 17, further configured to respond to an unsuccessful result of the offline authentication by prohibiting the user from inputting further authentication information until a time delay period has expired, or by refraining from performing offline authentication based on user-input authentication information until a time delay period has expired.

Ex. 19. The control circuitry of Ex. 18, configured to increase the duration of the time delay period after each successive unsuccessful result of the offline authentication.

Ex. 20 The control circuitry of any of examples Ex. 1-Ex. 19, further configured to compare the user-input authentication information with prestored reference authentication information and to determine, based on an outcome of the comparison, whether to transition the aerosol-generating device from the locked state to the unlocked state.

Ex. 21 The control circuitry of any of examples Ex. 1-Ex. 20, further configured to transition the aerosol-generating device to the unlocked state in response to determining to transition the aerosol-generating device from the locked state to the unlocked state based on a successful result of the offline authentication.

Ex. 22 The control circuitry of example Ex. 21, further configured to transition the aerosol-generating device to the unlocked state by one or more of (i) modifying a value of an authentication indicator stored in data storage, (ii) adding an authentication indicator to data storage, (iii) removing an authentication indicator from data storage.

Ex. 23 The control circuitry of example Ex. 21 or Ex. 22, further configured to transition the aerosol-generating device to the unlocked state by enabling one or more functions of the aerosol-generating device that was previously disabled when the aerosol-generating device was in the locked state.

Ex. 24 The control circuitry of any of examples Ex. 21-Ex. 23, further configured to transition the aerosol-generating device to the unlocked state by transmitting an unlock signal to a companion device for the aerosol-generating device, the companion device being configured to enable, in response to receipt of the unlock signal, one or more functions of one or more of the aerosol-generating device and the companion device that was previously disabled when the aerosol-generating device was in the locked state.

Ex. 25 The control circuitry of example Ex. 23 or Ex. 24, wherein the one or more functions enabled in the unlocked state are essential for the delivery of aerosol by the aerosol-generating device, the enabling comprising enabling one or more of: (i) electrical energy supply components, (ii) vaporizable-liquid supply components, (iii) heating elements, (iv) airflow-enabling components.

Ex. 26 The control circuitry of any of examples Ex. 21-Ex. 25, wherein the control circuitry is further configured to transition the aerosol-generating device to the unlocked state by disabling one or more mechanical lock components.

Ex. 27 The control circuitry of any of examples Ex. 1-Ex. 26, further configured to determine not to transition the aerosol-generating device from the locked state to the unlocked state based on an unsuccessful result of the offline authentication.

Ex. 28 The control circuitry of any of examples Ex. 1-Ex. 27, further configured to maintain the aerosol-generating device in the locked state in response to determining not to transition the aerosol-generating device from the locked state to the unlocked state based on an unsuccessful result of the offline authentication.

Ex. 29 The control circuitry of any of examples Ex. 1-Ex. 28, further configured to perform offline authentication of the aerosol-generating device without being connected to an external computing device during the authentication.

Ex. 30 The control circuitry of any of examples Ex. 1-Ex. 29, further configured to perform offline authentication of the aerosol-generating device without transmitting authentication-relevant data to, or receiving authentication-relevant data from, an external computing device during the authentication.

Ex. 31 An aerosol-generating device comprising the control circuitry of any of examples Ex. 1-Ex. 30.

Ex. 32 A companion device for an aerosol-generating device, the companion device comprising the control circuitry of any of examples Ex. 1-Ex. 30.

Ex. 33 A system comprising an aerosol-generating device, a companion device for the aerosol-generating device, and the control circuitry of any of examples Ex. 1-Ex. 30.

Ex. 34 A method for authenticating an aerosol-generating device for use, the aerosol-generating device having a locked state in which the aerosol-generating device is prohibited from delivering aerosol and an unlocked state in which the aerosol-generating is permitted to deliver aerosol, the method comprising:
receiving user-input authentication information from one or more user interface components during multiple time windows of predetermined duration, each time window corresponding to a respective digit of a sequence of digits forming the authentication information, and attributing user input received via the user interface components during a said time window to the digit corresponding to the said time window;
performing offline authentication of the aerosol-generating device based on the user-input authentication information; and
determining to transition the aerosol-generating device from the locked state to the unlocked state based on a successful result of the offline authentication.

Ex. 35 The method of example Ex. 34, further comprising controlling the user interface components to guide the user in inputting the authentication information as part of a guided interactive input process.

Ex. 36 The method of example Ex. 35, further comprising controlling the user interface components to output user-perceptible guidance signals in response to control signals from the control circuitry for guiding the user during the guided interactive input process.

Ex. 37. The method of example Ex. 36, further comprising controlling the user interface components to output the user-perceptible guidance signals to (i) prompt the user to take predetermined action, to (ii) provide the user with feedback relating to progress of the guided interactive input process, or both (i) and (ii).

Ex. 38 The method of example Ex. 36 or Ex. 37, further comprising controlling the user interface components to output user-perceptible guidance signals comprising any one or more of visual signals, audible signals, and haptic signals.

Ex. 39 The method of any of examples Ex. 34-Ex. 38, further comprising triggering a timeout in response to no user input being received by the one or more user interface components within a predetermined time period starting from the beginning of a respective one of the time windows.

Ex. 40 The method of example Ex. 39, further comprising determining not to transition the aerosol-generating device to the unlocked state in response to the triggering of the timeout.

Ex. 41. The method of any of examples Ex. 34-Ex. 740, further comprising initiating a first one of the time windows in response to a user interacting with the one or more user interface components.

Ex. 42. The method of Ex. 41, further comprising initiating the first one of the time windows in response to receiving a predetermined signal generated by the user interacting with the one or more user interface components.

Ex. 43. The method of Ex. 42, wherein the one or more user interface components comprise a pushbutton, and the predetermined signal is generated by the user pressing the pushbutton a predetermined number of times.

Ex. 44. The method of any of examples Ex. 34-Ex. 43, wherein before and/or during one or more of the time windows, there is a preliminary time window, the method further comprising determining an unsuccessful result of the offline authentication if no user-input authentication is received during the preliminary time window, or storing the received user-input authentication and initiating the corresponding time window and/or continuing to run the corresponding time window if user-input authentication is received during the preliminary time window.

Ex. 45 The method of any of examples Ex. 34-Ex. 44, further comprising controlling the user interface components to output user-perceptible guidance signals indicating at least the beginnings of respective time windows.

Ex. 46. The method of any of examples Ex. 34-Ex. 45, further comprising controlling the user interface components to output user-perceptible guidance signals indicating that the said time window is running.

Ex. 47 The method of any of examples Ex. 34-Ex. 46, further comprising controlling the user interface components to output user-perceptible guidance signals indicating for which digit of the sequence the user is being guided to provide input.

Ex. 48. The method of Ex. 47, wherein the aerosol-generating device is provided with a number of output elements corresponding to the number of digits in the sequence, and wherein the position of an active output element with respect to inactive output elements indicates the position of the digit within the sequence for which input is expected.

Ex. 49 The method of any of examples Ex. 34-Ex. 48, further comprising interpreting multiple signals arising from repeated user operation of a same said user interface component during a said time window as a coded input signal defining the digit of the sequence to which the said time window corresponds.

Ex. 50. The method of any of Ex. 34-Ex. 49, further comprising responding to an unsuccessful result of the offline authentication by prohibiting the user from inputting further authentication information until a time delay period has expired, or by refraining from performing offline authentication based on user-input authentication information until a time delay period has expired.

Ex. 51. The method of Ex. 50, further comprising increasing the duration of the time delay period after each successive unsuccessful result of the offline authentication.

Ex. 52 The method of any of examples Ex. 34-Ex. 51, further comprising comparing the user-input authentication information with prestored reference authentication information and determining, based on an outcome of the comparison, whether to transition the aerosol-generating device from the locked state to the unlocked state.

Ex. 53 The method of any of examples Ex. 34-Ex. 52, further comprising transitioning the aerosol-generating device to the unlocked state in response to determining to transition the aerosol-generating device from the locked state to the unlocked state based on a successful result of the offline authentication.

Ex. 54 The method of example Ex. 53, further comprising transitioning the aerosol-generating device to the unlocked state by one or more of (i) modifying a value of an authentication indicator stored in data storage, (ii) adding an authentication indicator to data storage, (iii) removing an authentication indicator from data storage.

Ex. 55 The method of example Ex. 53 or Ex. 54, further comprising transitioning the aerosol-generating device to the unlocked state by enabling one or more functions of the aerosol-generating device that was previously disabled when the aerosol-generating device was in the locked state.

Ex. 56 The method of any of examples Ex. 42-Ex. 55, further comprising transitioning the aerosol-generating device to the unlocked state by transmitting an unlock signal to a companion device for the aerosol-generating device, the companion device enabling, in response to receipt of the unlock signal, one or more functions of one or more of the aerosol-generating device and the companion device that was previously disabled when the aerosol-generating device was in the locked state.

Ex. 57 The method of example Ex. 55 or Ex. 56, wherein the one or more functions enabled in the unlocked state are essential for the delivery of aerosol by the aerosol-generating device, the enabling comprising enabling one or more of: (i) electrical energy supply components, (ii) vaporizable-liquid supply components, (iii) heating elements, (iv) airflow-enabling components.

Ex. 58 The method of any of examples Ex. 53-Ex. 57, further comprising transitioning the aerosol-generating device to the unlocked state by disabling one or more mechanical lock components.

Ex. 59 The method of any of examples Ex. 34-Ex. 58, further comprising determining not to transition the aerosol-generating device from the locked state to the unlocked state based on an unsuccessful result of the offline authentication.

Ex. 60 The method of any of examples Ex. 34-Ex. 59, further comprising maintaining the aerosol-generating device in the locked state in response to determining not to transition the aerosol-generating device from the locked state to the unlocked state based on an unsuccessful result of the offline authentication.

Ex. 61 The method of any of examples Ex. 34-Ex. 60, further comprising performing offline authentication of the aerosol-generating device without being connected to an external computing device during the authentication.

Ex. 62 The method of any of examples Ex. 34-Ex. 61, further comprising performing offline authentication of the aerosol-generating device without transmitting authentication-relevant data to, or receiving authentication-relevant data from, an external computing device during the authentication.

Ex. 63 The method of any of examples Ex. 34-Ex. 62, performed by control circuitry of the aerosol-generating device.

Ex. 64 The method of any of examples Ex. 34-Ex. 62, performed by control circuitry of a companion device for the aerosol-generating device.

Ex. 65 The method of any of examples Ex. 34-Ex. 62, performed by control circuitry of a system comprising the aerosol-generating device and a companion device for the aerosol-generating device.

Ex. 66 A method comprising generating authentication information for offline authentication of an aerosol-generating device and sending the authentication information to the user for input to the control circuitry of any of examples Ex. 1-Ex. 30 as the user-input authentication information.

Ex. 67 The method of example Ex. 66, wherein generating the authentication information comprises receiving an identity code from the user and generating the authentication information based on the received identity code.

Ex. 68 The method of example Ex. 66 or Ex. 67, further comprising, before generating the authentication information, performing an age verification process to verify the age of the user, and generating the authentication information only in response to a successful outcome of the age verification process.

Ex. 69 A server computer comprising a processor configured to perform the method of any of examples Ex. 66-Ex. 68.

Ex. 70 A computer program product comprising instructions which, when the program is executed by a server computer, cause the server computer to perform the method of any of examples Ex. 66-Ex. 68.

Examples will now be further described with reference to the drawings in which:—

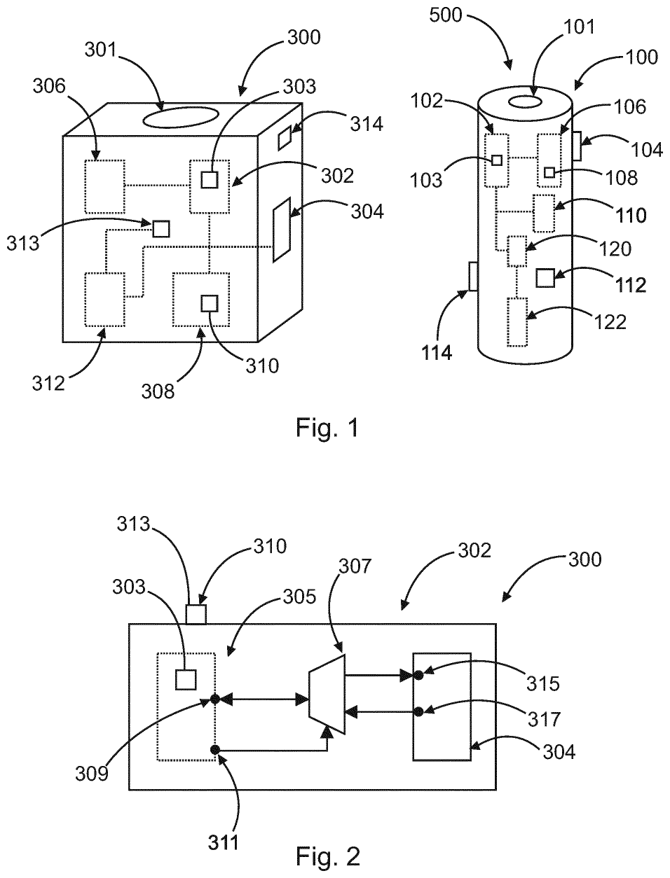

FIG. 1 shows an aerosol-generating system;

FIG. 2 shows a block diagram of a part of a companion device in the aerosol-generating system of FIG. 1;

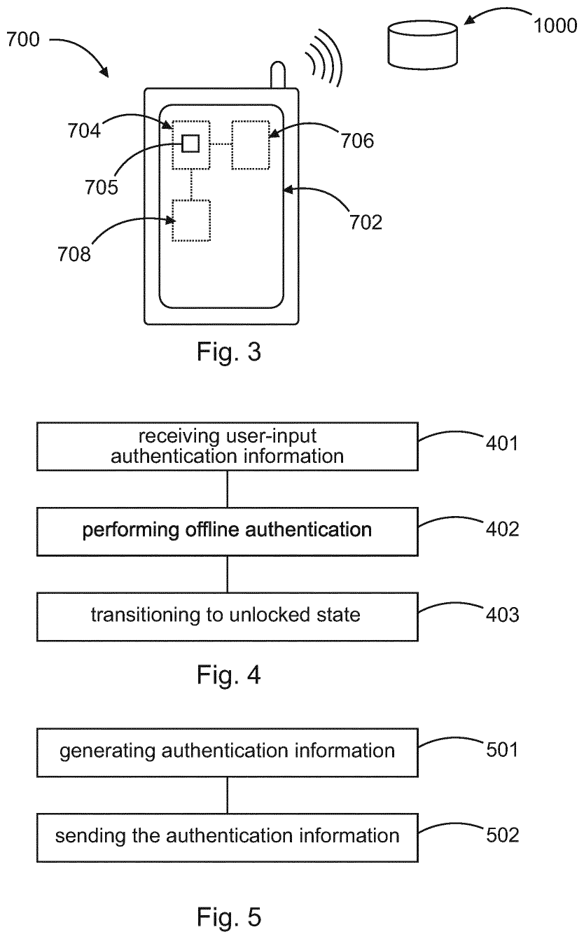

FIG. 3 shows an external computing device for use in conjunction with the aerosol-generating system of FIG. 1;

FIG. 4 shows a flowchart illustrating a method for authenticating an aerosol-generating device in the aerosol-generating system of FIG. 1 for use;

FIG. 5 shows a flowchart illustrating a method involving generating authentication information and sending it to the user; and

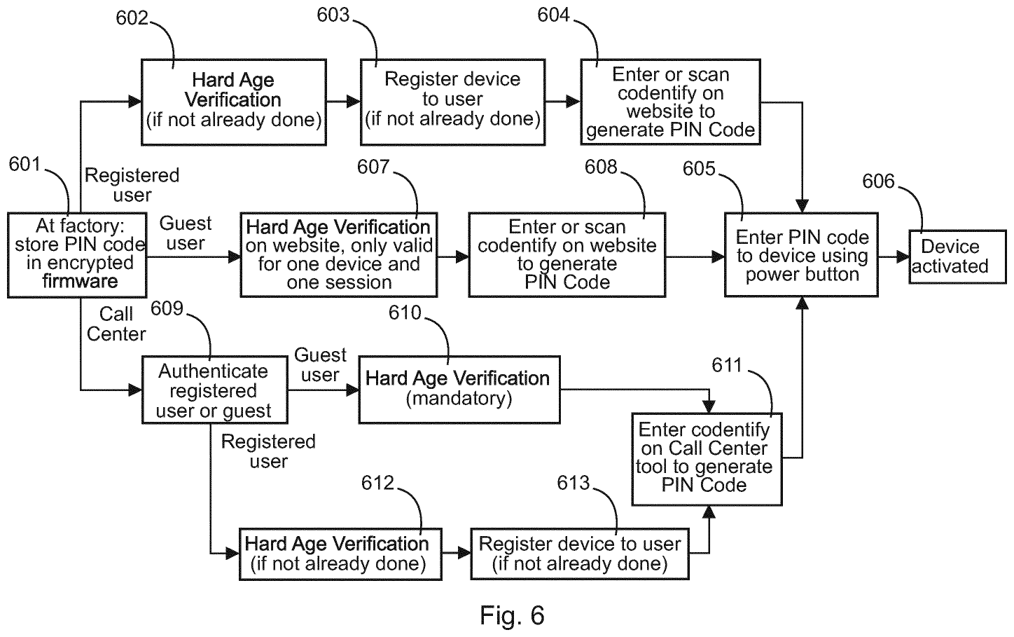

FIG. 6 is a flowchart illustrating a method of device activation.

The drawings are schematic only and not true to scale.

FIG. 1 shows an aerosol-generating system 500 for generating aerosol, for example for consumption by a user. The system 500 comprises an aerosol-generating device 100 for generating aerosol and a companion device 300 for at least partially receiving the aerosol-generating device 100. The companion device 300 may be a charging device for charging the aerosol-generating device 100.

The aerosol-generating device 100 comprises an insertion opening 101 for at least partially inserting an aerosol-generating article (not shown). The aerosol-generating article may comprise an aerosol-forming substrate, such as a tobacco containing substrate, and/or a cartridge comprising a liquid.

The aerosol-generating device 100 further includes control circuitry 102 with one or more processors 103. The control circuitry 102 may be configured to control actuation, activation and/or deactivation of the at least one heating element 120.

The aerosol-generating device 100 further comprises user interface components comprising an input element in the form of a pushbutton 104. The pushbutton 104 is actuatable by the user to input a pin code to the control circuitry 102, as described further below. Following successful completion of the authentication, the pushbutton 104 may furthermore be used as a power button to activate or deactivate the heating element 120 for aerosol generation thereby to activate or deactivate the aerosol-generating device 100. Upon activation of the aerosol-generating device 100, the heating element 120 may be activated and heat may be applied to at least a part of the aerosol-generating article, such that aerosol can be generated for consumption by the user. Upon deactivation of the aerosol-generating device 100, the heating element 120 may be deactivated such that no or reduced heat may be applied to the at least a part of the aerosol-generating article, such that no aerosol can be generated for consumption by the user.

The aerosol-generating device 100 further comprises a communications arrangement 106 with one or more communications interfaces 108 for communicatively coupling the aerosol-generating device 100 with the companion device 300, for example, via an Internet connection, a wireless LAN connection, a WiFi connection, a Bluetooth connection, a mobile phone network, a 3G/4G/5G connection, an edge connection, an LTE connection, a BUS connection, a wireless connection, a wired connection, a radio connection, a near field connection, and/or an IoT connection.

The aerosol-generating device 100 further comprises a data storage 110 for storing information or data, such as at least one authentication indicator and/or other data.

The user interface components further comprise output elements in the form of an LED array 112 and a haptic output element (not shown) for providing haptic pulses. The output elements provide user-perceptible guidance signals to the user. The LED array 112 may furthermore be used for indicating a charge level of the at least one energy storage 122, indicating that the at least one energy storage should be charged, or the like, for example. The LED array 112 may also be used for indicating a configuration or state of the aerosol-generating device 100, for example whether the aerosol-generating device is in a locked or unlocked state.

The aerosol-generating device 100 further comprises at least one electrical connector 114 for coupling to a corresponding at least one electrical connector 313 of the companion device 300. For example, when the aerosol-generating device 100 is at least partially inserted into the opening 301 of the companion device 300, the one or more electrical connectors 114 of the aerosol-generating device 100 may be coupled with the one or more electrical connectors 313 of the companion device 300 to charge the at least one energy storage 122 of the aerosol-generating device 100.

For generating the aerosol during use or consumption of the aerosol-generating article, the aerosol-generating device 100 comprises at least one heating element 120 or heat source 120 for applying heat to at least a portion of the aerosol-generating article.

For powering the at least one heating element 120 with electrical power, the aerosol-generating device 100 further comprises at least one energy storage 122 or energy supply 122 for storing electrical energy or power.

The aerosol-generating device 100 has a locked state in which the aerosol-generating device 100 is prohibited from delivering aerosol and an unlocked state in which the aerosol-generating 100 is permitted to deliver aerosol.

In use, the control circuitry 102 is configured to receive user-input authentication information from the user interface components; perform offline authentication of the aerosol-generating device based on the user-input authentication information; and determine to transition the aerosol-generating device from the locked state to the unlocked state based on a successful result of the offline authentication.

The control circuitry 102 is configured to control the user interface components to guide the user in inputting the authentication information as part of a guided interactive input process, also referred to herein as an offline YAP process. In particular, the control circuitry 102 is configured to control the user interface components to output user-perceptible guidance signals in response to control signals from the control circuitry 102 for guiding the user during the offline YAP process. The user-perceptible guidance signals prompt the user to take predetermined action and provide the user with feedback relating to progress of the offline YAP process. More particularly, the user is guided by the control circuitry 102 during the offline YAP process to unlock the device 100 by manually entering authentication information in the form of a pin code into the device 100 by pressing each digit into the device 100 in succession using the pushbutton 104.

One non-limiting example of the offline YAP process will now be described.

To enter the offline YAP process, the user presses the pushbutton 104 5 times over a period of 3 seconds. The device 100 reacts with a 1 second haptic pulse and a first LED of the array 112 (referred to herein as LED1) starts blinking to indicate to the user that the first digit of the pin code must be entered into the device 100. Thus, the first LED (LED1) corresponds to the first digit of the pin code. In this way, the control circuitry 102 controls the LED array 112 to indicate for which digit of the pin code the user is being guided to provide input. Additionally, the blinking of LED1 indicates to the user that a first time window is running during which the first digit should be entered. The beginning of the blinking indicates the start of the time window. The control circuitry 102 interprets multiple signals arising from repeated user operation of the pushbutton 104 during the first time window as a coded input signal defining the first digit of the pin code.

In one illustrative example, if the user wishes to enter the pin code 3521, the pushbutton 104 has to be pressed 3 times while LED1 is blinking during the first time window. The three signals resulting from the repeated presses of the pushbutton 104 during the first time window define a coded input signal which is interpreted by the control circuitry 102 as the digit “3”. Having been received during the first time window, this digit is attributed by the control circuitry 102 correspondingly to the first digit of the pin code.

To leave enough time for the user to start pressing the pushbutton 104, a double timeout is implemented. A first timeout is configured at 15 seconds to leave enough time for the user to understand the process. If the pushbutton 104 is not pressed within these first 15 seconds, the control circuitry determines not to transition the device 100 to the unlocked state. In one example, the device 100 switches off in response to the triggering of the first timeout. Once the pushbutton 104 is pressed once (before expiry of the first timeout), the second timeout starts and the user has a further 7 seconds to complete the first digit before the first time window ends. The end of the first time window defines the point at which the control circuitry 102 no longer attributes received user input to the first digit.

At the end of the first time window, LED1 switches off and LED2 starts blinking to indicate that the user is being guided to enter the second digit during a second time window having a predetermined duration of 7 seconds. While LED2 is blinking during the second time window, the user has to press the pushbutton 104 5 times (for the exemplary pin code 3521) to generate a coded input signal defining the second digit of the pin code.

At the end of the second time window, LED2 switches off and LED3 starts blinking to invite the user to enter the third digit. Continuing with the exemplary pin code 3521, while the LED3 is blinking during the 7-second third time window, the user has to press the pushbutton 104 2 times.

At the end of the third time window, LED3 switches off and LED4 starts blinking to invite the user to enter the fourth digit. Following the example above, while LED4 is blinking, the user has to press the pushbutton 104 only one time. At the end of the fourth time window, LED4 switches off and all the LEDs start to blink simultaneously for 3 seconds.

In this way, the control circuitry 102 receives the user input during multiple time windows of predetermined duration. Each time window corresponds to a respective digit of the pin code: the first time window corresponds to the first digit, the second time window corresponds to the second digit, and so on. The control circuitry 102 attributes user input received via the pushbutton 104 during one of time windows to the digit corresponding to that time window: user input received during the first time window is attributed to the first digit, user input received during the second time window is attributed to the second digit, and so on.

Following the end of the final time window, the control circuitry 102 compares the user-input pin code with a prestored reference pin code and determines, based on an outcome of the comparison, whether to transition the aerosol-generating device 100 from the locked state to the unlocked state. If the pin code was entered successfully, the device 100 is transitioned to the unlocked state and the device 100 becomes usable. If the pin was entered wrongly, the control circuitry determines not to transition the aerosol-generating device from the locked state to the unlocked state, for example by switching off the device 100. An exponential delay time may be imposed between re-trials of the pin code, to avoid people trying to brute force the process by trying many pin codes. If the pin is entered incorrectly a certain number of times (e.g. between one and five times), the device 100 may be blocked so that a pin code cannot be re-entered until a predetermined period of time has elapsed (e.g. 10 minutes to 24 hours). Once a pin code has been entered too many times incorrectly, a new pin code may have to be requested.

It will be understood that the use of a pushbutton, LEDs and haptics is merely illustrative and that other forms of input and output elements are contemplated by the present disclosure.

It will be understood that the length and format of the pin code and the encoding of digits described above are merely illustrative and that other coded sequences may be used which are preferably but not necessarily entered using a single input element or minimal input elements, including e.g. passwords formed for example by sequences of characters entered using e.g. a different encoding method, for example Morse code. The pin code could be of any suitable length and the range of numbers for each digit could be limited, e.g. to 5, or greater (e.g. 1 to 9).

Furthermore, the timing of the time windows and timeouts may be different to that described above without departing from the scope of the appended claims.

The aerosol-generating device 100 can comprise numerous alternative or additional features, for example as described with reference to any of the first to fifth aspects of the present disclosure.

The above operations have been described as being carried out under control of the control circuitry 102 of the aerosol-generating device 100. However, it will be understood that the above operations could equally be carried out by the companion device 300, more particularly by the control circuitry 302 thereof (as described below), or by the system 500 as a whole with the control being distributed between the control circuitry 102 of the aerosol-generating device 100 and the control circuitry 302 of the companion device 300.

Moreover, the user interface components used for input and output of information may comprise those of the aerosol-generating device 100, those of the companion device 300 (as described below), or any combination of input and output elements of the aerosol-generating device 100 and companion device 300.

To illustrate these possibilities further, the companion device 300 will now be described.

The companion device 300 may be configured for physically coupling the aerosol-generating device 100. For at least partially receiving the aerosol-generating device 100 and/or for physically coupling the aerosol-generating device 100 with the companion device 300, the companion device 300 includes an opening 301 or receiving opening 301, into which the aerosol-generating device 100 can be at least partially inserted, for example for storing and/or supporting the aerosol-generating device 100. Optionally, the companion device 300 may include a cover for opening and closing the opening 301.

Additionally or alternatively, the companion device 300 may be configured to at least partially receive the aerosol-generating device 100 based on coupling the aerosol-generating device 100 to a mechanical attachment or coupling mechanism of the companion device 300, for example a hook mechanism, a latch mechanism, a snap-fit, or the like. Additionally or alternatively, the companion device 300 may be configured to at least partially receive the aerosol-generating device 100 based on coupling the aerosol-generating device 100 with the companion device 300 by means of a magnetic or electromagnetic coupling.

For this purpose, the companion device 300 comprises a charger module 312 or charger circuitry 312 coupled to the electrical connector 313. The charger module 312 may, for example, be coupled to a supply grid for supplying the energy storage 122 of the aerosol-generating device 100 with electrical energy. Additionally or alternatively, the companion device 300 may comprise one or more batteries, accumulators, capacitors or the like.

The companion device 300 further comprises control circuitry 302 with one or more processors 303. The control circuitry 302 may be configured to control the charger module 312 and/or other components or functions of the companion device 300. It should be noted that also the charger circuitry or module 312 may be combined with or included in the control circuitry 302.

The control circuitry may be configured to perform the offline YAP process as described above, which will not be repeated here in the interests of brevity. However, the process in this example is similar to that described above but, in this example, the offline YAP process is performed at the control circuitry 302 at the companion device 300, rather than being performed by the control circuitry 102 at the aerosol-generating device 100. Thus, the user performs the offline YAP process by interacting with the companion device 300, rather than being required to interact with the aerosol-generating device 100. The control circuitry 302 may unlock or lock the aerosol-generating device in a variety of different ways following the YAP process. For instance, the control circuitry 302 of the companion device 300 may send a locking or an unlocking signal to the aerosol-generating device depending on whether the offline YAP process was successful or unsuccessful.

The companion device 300 comprises user interface components comprising a pushbutton 304 and a visual indicator 314, such as e.g. one or more LEDs 314 and/or an LED array 314.

The companion device 300 further comprises a data storage 306 for storing information or data, such as an authentication indicator, reference authentication information, and/or other data.

The control circuitry 302, data storage 306 and user interface components may be embodied in a single unit. In this way, it is possible for the user to be authenticated without the authentication information leaving the single unit, thus improving security.

The companion device 300 further comprises a communication arrangement 308 with one or more communications interfaces 310 for communicatively coupling the companion device 300 with the aerosol-generating device 100, for example, via an Internet connection, a wireless LAN connection, a WiFi connection, a Bluetooth connection, a mobile phone network, a 3G/4G/5G connection, an edge connection, an LTE connection, a BUS connection, a wireless connection, a wired connection, a radio connection, a near field connection, and/or an IoT connection.

FIG. 2 is a block diagram showing the companion device 300 in more detail. Specifically, FIG. 2 schematically shows at least a part 305 of the control circuitry 302, which includes the at least one processor 303 and which is coupled with the pushbutton 304 via a multiplexer 307. Therein, the part 305 may be coupled with or comprise the charger circuitry 312 and/or other electrical components of the companion device 300. For example, the at least part 305 of the control circuitry 302 exemplary shown in FIG. 2 may refer to a main controller 305 of the companion device 300.

Further, a port 309, such as a one-wire MT communication port (referred to as “MTRTX” port), may be used for coupling the control circuitry 302 to the multiplexer 307. This one-wire communication may be converted via the multiplexer 307 to a two-wire communication. For example, signals can be transmitted from the multiplexer 307 to an input port 315 (such as an RX port) of the pushbutton 304, and signals can be transmitted from an output port 317 (such as a TX port) of the pushbutton 304 to the multiplexer 307. Therein, the multiplexer 307 may be controlled by the control circuitry 302 via a port 311.

Further, in the example shown in FIG. 2, at least one communications interface 310 is combined with or integrated in the electrical connector 313, such that an electrical connection for charging the energy storage 122 of the aerosol-generating device 100 and a communicative coupling between the aerosol-generating device 100 and the companion device 300 can be established via the electrical connector(s) 114 of the aerosol-generating device 100 and the connector(s) 313 of the companion device.

FIG. 3 shows an external computing device 700 which may or may not be used in conjunction with the aerosol-generating system 500. The external computing device 700 comprises a user interface 702, control circuitry 704 comprising one or more processors 705 for data processing, a communications interface 706 for communicatively coupling the external computing device 700 to one or more of a server 1000 or the aerosol-generating system 500, and a data storage 708 for storing data or information.

FIG. 4 shows a flowchart illustrating a method for authenticating the aerosol-generating device 100 for use. Unless stated otherwise, the aerosol-generating device 100 comprises the same features, elements and/or functions as described elsewhere herein.

Step 401 comprises receiving user-input authentication information from one or more user interface components during multiple time windows of predetermined duration, each time window corresponding to a respective digit of a sequence of digits forming the authentication information, and attributing user input received via the user interface components during a said time window to the digit corresponding to the said time window.

Step 402 comprises performing offline authentication of the aerosol-generating device 100 based on the user-input authentication information.

Step 403 comprises determining to transition the aerosol-generating device 100 from the locked state to the unlocked state based on a successful result of the offline authentication.

The method illustrated in FIG. 4 can comprise numerous alternative or additional steps, for example as described with reference to any of the first to fifth aspects of the present disclosure.

FIG. 5 shows a flowchart illustrating a method in which step 501 comprises generating authentication information for offline authentication of the aerosol-generating device 100 and in which step 502 comprises sending the authentication information to the user for input to the control circuitry 102 and/or 302 as the user-input authentication information.

Unless stated otherwise, the aerosol-generating device 100 as well as the control circuitry 102 and/or 302 comprise the same features, elements and/or functions as described elsewhere herein.

The method illustrated in FIG. 5 can comprise numerous alternative or additional steps, for example as described with reference to any of the sixth to eighth aspects of the present disclosure.

FIG. 6 is a flowchart illustrating a method of device activation including steps from preparation in the factory to user activation. Step 601 comprises, at the factory, storing the pin code in encrypted firmware of the aerosol-generating device 100. The user then obtains the device 100 and activates it for use using one of the flows beginning with steps 602, 607, and 609, respectively. In the case that the user is already registered, the method proceeds to step 602, at which hard age verification is performed, if this has not already been done. Step 603 comprises registering the device 100 to the user, if this has not already been done. Step 604 comprises the user entering or scanning an identity code (“codentify”) on the website to generate the pin code described elsewhere herein. Step 605 comprises the user entering the pin code into the device 100 using the pushbutton 104, in the manner described above. At step 606, the device 100 is activated for use following successful authentication, as described above. In the case that the user is not already registered, the method proceeds instead from step 601 to step 607, at which hard age verification is again performed on the website, with this being only valid for one device and for one session, with the user being a guest user. Step 608 comprises the user entering or scanning the identity code on the website to generate the pin code, as was done in step 604. The method again then proceeds to step 605. In the case that the user is not able to access the website, the user may call the call centre, in which case the method proceeds from step 601 to step 609, in which the user is authenticated as a registered user or guest. For a guest user, the method proceeds to step 610, and which hard age verification is performed. Step 611 comprises the user entering the identity code on a call centre tool to generate the pin code before the method proceeds to step 605. For a registered user, the method proceeds from step 609 to step 612 at which hard age verification is performed, if this has not already been done. Step 613 comprises registering the device 100 to the user, if this is not already been done. The method then proceeds to step 611.

In FIG. 6, generating the pin code corresponds to step 501 of FIG. 5, while the user obtains the pin code via the website or call centre in steps corresponding to step 502. Hard age verification may also be referred to herein as an age verification process.

Significantly, entry of the pin code in step 605 does not require any connectivity between the aerosol-generating device 100 (or companion device 300) and any external computing device (such as that described above) nor the use of any app for this purpose.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-15. (canceled)

16. Control circuitry for an aerosol-generating device, the aerosol-generating device having a locked state in which the aerosol-generating device is prohibited from delivering aerosol and an unlocked state in which the aerosol-generating device is permitted to deliver aerosol, the control circuitry being configured to:
receive user-input authentication information from one or more user interface components, wherein the control circuitry is further configured to receive the user-input authentication information during multiple time windows of predetermined duration, each time window corresponding to a respective digit of a sequence of digits forming the authentication information, and to attribute user input received via the user interface components during a time window of the multiple time windows to the digit corresponding to said time window,
perform offline authentication of the aerosol-generating device based on the user-input authentication information,
determine to transition the aerosol-generating device from the locked state to the unlocked state based on a successful result of the offline authentication, and
interpret multiple signals arising from repeated user operation of a same user interface component during said time window as a coded input signal defining the digit of the sequence to which said time window corresponds.

17. The control circuitry according to claim 16, wherein the control circuitry is further configured to trigger a timeout in response to no user input being received by the one or more user interface components within a predetermined time period starting from the beginning of a respective one of the time windows.

18. The control circuitry according to claim 16, wherein the control circuitry is further configured to initiate a first one of the time windows in response to a user interacting with the one or more user interface components.

19. The control circuitry according to claim 18, wherein the control circuitry is further configured to initiate the first one of the time windows in response to receiving a predetermined signal generated by the user interacting with the one or more user interface components.

20. The control circuitry according to claim 19, wherein the one or more user interface components comprise a pushbutton, and the predetermined signal is generated by the user pressing the pushbutton a predetermined number of times.

21. The control circuitry according to claim 16,
wherein before and/or during one or more of the time windows, there is a preliminary time window, and
wherein the control circuitry is further configured to determine an unsuccessful result of the offline authentication if no user-input authentication is received during the preliminary time window, and to store the received user-input authentication and to initiate the corresponding time window and/or to continue running the corresponding time window if user-input authentication is received during the preliminary time window.

22. The control circuitry according to claim 16, wherein the control circuitry is further configured to control the user interface components to output user-perceptible guidance signals indicating at least the beginnings of respective time windows.

23. The control circuitry according to claim 16, wherein the control circuitry is further configured to control the user interface components to output user-perceptible guidance signals indicating that said time window is running.

24. The control circuitry according to claim 16, wherein the control circuitry is further configured to control the user interface components to output user-perceptible guidance signals indicating for which digit of the sequence the user is being guided to provide input.

25. The control circuitry according to claim 24,
wherein the aerosol-generating device is provided with a number of output elements corresponding to the number of digits in the sequence, and
wherein the position of an active output element with respect to inactive output elements indicates the position of the digit within the sequence for which input is expected.

26. The control circuitry according to claim 16, wherein the user interface component is a power button of the aerosol-generating device.

27. The control circuitry according to claim 16, wherein the control circuitry is further configured to respond to an unsuccessful result of the offline authentication by prohibiting the user from inputting further authentication information until a time delay period has expired, or by refraining from performing offline authentication based on user-input authentication information until a time delay period has expired.

28. The control circuitry according to claim 27, wherein the control circuitry is further configured to increase the duration of the time delay period after each successive unsuccessful result of the offline authentication.

29. An aerosol-generating device or an aerosol-generating system comprising an aerosol generating device, wherein the aerosol-generating device or the system comprises the control circuitry of according to claim 16.
